(19) United States
(12) Patent Application Publication
(10) Pub. No.: US 2020/0038808 A1
(43) Pub. Date: Feb. 6, 2020

(54) INTEGRATED REVERSE OSMOSIS AND MEMBRANE CLEANING SYSTEMS FOR FOULING PREVENTION

(71) Applicant: DESALSTECH LTD, Kfar Saba (IL)

(72) Inventor: Avi EFRATY, Har Adar (IL)

(21) Appl. No.: 16/485,456

(22) PCT Filed: Feb. 7, 2018
(86) PCT No.: PCT/IL2018/050140

§ 371 Date: Aug. 13, 2019

(30) Foreign Application Priority Data
Mar. 14, 2017 (IL) 251168

(51) Int. Cl. B01D 61/02; B01D 61/58; C02F 1/44; C02F 5/08

(52) U.S. Cl. CPC B01D 61/02; C02F 5/08; C02F 1/44; B01D 61/58

(57) ABSTRACT

An integrated system comprising a closed circuit desalination (CCD) unit with membrane cleaning (MC) means wherein the latter are activated briefly (≤8 minute) on a frequent basis, once a day or several days, for removal of fouling and/or scaling deposits off membrane surfaces created during the elapsed time interval and thereby, avoiding their accumulation and the need of CIP. MC proceeds in a tie-line sequence with different reagents solution in permeate known to affect the removal of common fouling and/or scaling constituents from membrane surfaces such as organic and/or bioorganic substances and/or inorganic scaling constituents including silica and polymerized silica coatings with either metal hydroxides or organic substances. Removal of silica containing deposits from membrane surfaces proceeds by a brief exposure to diluted hydrofluoric acid solution in permeate in the absence of interfering metal ions (e.g., Ca). The MC sequence incorporate both reverse osmosis (RO) and direct osmosis (DO) principles, the former to enable an effective contact of the cleaning reagents with membrane surfaces and the latter for inside-out backwash of semi-permeable membranes with permeate.

The fully computerized inventive system should enables a near perfect removal of all fouling and/or scaling constituents off membrane surfaces at an early stage on a regular basis before their accumulation and thereby, preventing the need for CIP and avoiding irreversible damage membranes as result of accumulation of irremovable fouling constituents.

### FIELD OF THE INVENTION

Fouling and scaling prevention of reverse osmosis desalination

### INVENTIVE SYSTEM

Integrated system comprising a closed circuit desalination (CCD) unit with membrane cleaning (MC) means for brief (˜5 minute) removal of fouling and/or scaling deposits off membrane surfaces to avoid their accumulation and the need of CIP.

### BACKGROUND OF THE INVENTION

Over the past 60 year, reverse osmosis (RO) has became the most worldwide practiced membrane technology for diverse applications such as desalination of brackish water (BWRO) and seawater (SWRO), treatment of domestic and industrial water supplies, treatment and recycling of domestic and industrial effluents, and more. RO technologies are broadly divided into continuous plug flow desalination (PFD) processes and non-continuous close circuit desalination (CCD) processes of entirely different design features and operational principles.

A continuous PFD process, henceforth conventional RO, proceeds with the splitting of a fixed pressurized feed stream at inlet to typical RO unit into two streams at the outlet one of non-pressurize permeate and the other of pressurized brine. Recovery in PFD depends on the number of lined elements (head to tail) inside the pressure vessels and characterized by 40%-50% recovery for single stage SWRO-PFD units with modules of ⅞-element each, and by 75% to 90% recovery for BWRO-PFD units with modules of 6-element each arranged in skids of two-stage and three-stage configuration, respectively. Energy consumption efficiency in PFD depends on the ability to recovery energy from the disposed pressurized brine effluent stream by means of so-called energy recovery devices (ERD) which act as pressure exchangers.

In contrast with PFD, the more recently conceived CCD methods relate to batch CCD processes under fixed low and variable pressure conditions made continuous by consecutive sequential techniques such as with an engaged/disengaged side conduit (Efraty, PCT/IL2004/000748; e.g., U.S. Pat. No. 7,628,921) or with brief PFD steps of brine replacement by feed between CCD sequences (Efraty, PCT/IL2005/000670, e.g., U.S. Pat. Nos. 7,695,614 and 8,025,804). CCD apparatus comprise a single stage RO skid with parallel modules of 314-element each, and a closed circuit concentrate recycling line from outlet to inlet of said skid wherein, the recycled concentrate is diluted with fresh pressurized feed at skids inlet. CCD proceeds under fixed flow and variable pressure conditions with selected CCD operational set-points of feed flow (=permeate flow), cross-flow, and batch sequence recovery, or their equivalents such flux, module recovery, and maximum applied pressure or maximum electric conductivity of recycled concentrated at the selected batch sequence recovery. Online selection and/or change of set-points of operation enable high performance flexibility and extensive optimization means of CCD processes. Recovery of CCD is the highest allowed by the constituents of the feed source and this process proceeds with a low energy demand since the applied pressure rises with recovery in the absence of any pressurized brine release.

Commercial RO membranes are available with different specifications depending on their intended application and a durable membrane performance requires an occasional membrane cleaning, so-call “dean in place” (CIP), to remove fouling deposits off membrane surfaces. Membrane fouling, defined by IUPAC as “a process resulting in loss of performance of a membrane due to the deposition of suspended or dissolved substances on its external surfaces, at its pore openings or within pores”, is the single greatest drawback of RO techniques since requires stopping desalination in favor of lengthy effective CIP operations. If fouling and/or scaling constituents are not removed on time, their subsequent removal becomes more difficult, or impossible, and this may cause a substantial loss of membrane performance due to an irreversible damage. Accordingly, reliable criteria of online monitored data had to be developed in order to warn for need of CIP before an irreversible damage beyond repairs is caused to membranes. The PFD and CCD methods of different design features and operational principles also differ in their fouling and scaling propensities and means to determine need for CIP.

RO failure incidence (%) of conventional RO techniques have been attributed to mechanical damage (3%); membrane degradation (18%); particulate matter fouling (14%); organic fouling (12%); coagulant fouling (4%); bio-fouling (34%); silica scaling (10%); and other inorganic scaling (5%) such as of CaCO₃; CaSO₄; Ca₃PO₄)₂; BaSO₄; SrSO₄; and magnesium, ferric and aluminum hydroxides. Membrane fouling (79%) accounts to 4 of every 5 RO failures, with bio-fouling (34%) being the dominant fouling factor, and together with organic fouling (12%) accounts to 3 of every 4 RO failures. Increased fouling and scaling propensity of conventional RO techniques relates to need of an increased lined-element number to achieve higher recovery as well as to the declined flux and cross-flow experienced by tail elements in modules. Need for CIP of convention RO systems is suggested by a 10% drop of normalized permeate flow and/or a 5%→10% increase of normalized salt passage and/or a 10%→15% increase of Δp (module inlet-outlet pressure difference)−Δp correlates to pressure losses of flow friction origin inside pressure vessels with an increased channel blockage inside spiral wound membrane elements manifested by a greater Δp.

In contrast with conventional RO processes, the different design features and operational principles of the consecutive sequential batch CCD lead to low fouling and scaling propensities without any bio-fouling. In CCD, frequent large salinity variations of the recycled concentrate inside short modules, ¾-element each, under a controlled cross-flow and concentration polarization factor, create adverse conditions for bacteria growth and proliferation manifested the absence of bio-fouling. Moreover, the mixing of recycled concentrates with fresh pressurized feed at inlet(s) to CCD module(s) under low concentration polarization conditions of controllable cross flow, cause the appearance of first scaling signs near the highest attainable recovery of a specific source and thereafter, the flushing of brine during the brief PFD steps between the CCD sequences according to the PCT/IL2005/000670 technology removes all particulate matter from the pressure vessel, including small amounts of scaling particles if formed. The PFD brine flush step in said CCD process takes place under a reduced applied pressure, higher than the osmotic pressure of the feed but lower than that of replaced brine, and this creates a tie-line with RO desalination of received feed and direct osmosis (DO) of the replaced brine whereby membranes are backwashed inside-out with permeate after each CCD sequence. A schematic illustration of a small section of two parallel semi-permeable surfaces inside a typical spiral wound commercial element shows permeate flow direction under CCD conditions (FIG. 1A) and during PFD brine replacement by feed of RO→DO inversion (FIG. 1B). Accordingly, the cleaning effect during the frequent PFD steps in said CCD processes also incorporate an inside-out DO backwash of membranes during the replacement of brine by fresh feed and this helps the rupture deposits off membrane surfaces and the removal of their debris together with other undesirable particulate matter from inside elements.

Online DO backwash methods of semi-permeable membranes in conventional RO processes by net driving pressure manipulation through a brief salinity change of feed are disclosed in U.S. Pat. No. 7,658,852 B2 (Igal Liberman) and in U.S. Pat. No. 7,563,375 B2 (Boris Liberman). Backwash of membranes by increasing the permeate pressure over the osmotic pressure of the feed solution is another membrane backwash technique disclosed in the literature (Sagiv et. al (EDS Conference, L'Aquila, Italy, Nov. 15-17, 2004, pp 150-151, Abstract No 934).

Common deposits on RO membrane surfaces comprise of organic and/or bioorganic substances and/or inorganic scaling constituents including silica and polymerized silica coatings with either metal hydroxides or organic substances. Extensive and diverse chemical cleaning procedures were developed over the years for RO membrane cleaning (MC) by a so-called “clean in place” (CIP) approach which requires the stopping of RO plants for 6-12 hour periods at a time. Barium sulfate and silica are the most difficult deposits for removal off membrane surfaces and while the barium sulfate problem is of lesser significance since barium is normally found in trace amounts in common feed sources, the problem of silica fouling is major and widespread in light of its relatively high abundance in many feed sources. A noteworthy disclosure (Mukherjee et al., J. Mem. Sci., 97(1994) 231-249) described the performance (flux and NaCl rejection) of a SW30HR commercial element after exposure to hydrofluoric add (5-15 wt %) for periods up to 35 days, and this study revealed a large flux enhancement without change in rejection. These findings suggest the plausible use of hydrofluoric acid as an effective cleaning reagent for removal of silica deposits off membrane surfaces, provided that such a treatment is carried out selectively in the absence of metal ions which form insoluble fluorides (e.g., CaF₂).

The present invention describes integrated reverse osmosis (RO) and membrane cleaning (MC) systems (RO-MC) for fouling prevention in CCD and conventional RO processes. A brief MC sequence in said integrated systems once a day or less frequently should enable foulants removal off membrane surfaces at their embryonic stage, thereby, avoid their accumulation and prevent the need of CIP operations.

### SUMMARY OF THE INVENTION

The invention describes integrated reverse osmosis (RO) and a membrane cleaning (MC) systems (RO-MC), with emphasis on RO closed circuit desalination (CCD) systems which operate under fixed flow and variable pressure conditions, wherein brief (e.g., ˜8 min) MC sequences are executed at a predefined interval (e.g., once a day or several days) with different appropriate reagents for foulants removal off membrane surfaces at their embryonic stage and thereby, avoiding the need for CIP and preventing irreversible damage to membranes due to the accumulation of foulants. The MC means of the inventive RO-MC system comprise a permeate tank fed by the RO unit in the system and a delivery system with pumps and valve means to enable permeate and its different membrane cleaning solutions reach membrane surfaces inside elements in a tie-line sequence for effective removal of all the foulants. During the brief MC mode of operation, RO is stopped, and the membranes inside the elements are exposed to different cleaning solutions, one after the other in a sequence according to the nature of the foulants. The MC operation takes place under a relatively low applied pressure (pₐ) and the osmotic pressure (π) of cleaning solutions modified by means of an electrolyte (e.g., NaCl) to enable the creation mild reverse osmosis (pₐ>π) or direct osmosis (pₐ>π) or their absence (pₐ=π) during the different steps of the MC sequence. MC under mild reverse osmosis conditions facilitate contact between cleaning reagents and membrane surfaces, whereas such an operation under direct osmosis conditions proceeds with backwash of membranes inside out and facilitates breakdown of foullants layers off membrane surfaces.

The inventive integrated RO-MC system should enable durable RO without need for CIP at the expense minor loss of daily permeate productivity (<0.5%), but at major gain of lost productivity during conventional CIP procedures. The invented integrated RO-MC system offers for the first time the prospects for desalination with near zero fouling and/or scaling, inrrespective of the types of foulants. While the inventive RO-MC system is not confined to a specific RO method, its highest effectiveness is expected with CCD apparatus of a single stage skid with short modules, each ordinarily of 3-4 elements, wherein the cleaning process takes place on a short line of elements. In contrast with CCD, conventional RO utilizes longer modules, each ordinarily of 6-8 elements, and this implies the MC needs of 6-8 lined elements per one-stage, 12 elements per two-stage and 18 elements per three-stage configurations of increased time duration and declined effectiveness.

### BRIEF DESCRIPTION OF THE DRAWINGS

FIG. 1A, showing channels between two parallel semi-permeable membrane surfaces in a typical spiral wound element during CCD with permeate flow direction indicated by arrows.

FIG. 1B, showing channels between two parallel semi-permeable membrane surfaces in a typical spiral wound element during the PFD flush in CCD with permeate flow direction indicated by arrows.

FIG. 2A, showing the configuration of an integrated CCD-MC inventive system during the CCD mode of operation, while said MC system is inactive—flow directions indicated by arrows.

FIG. 2B, showing the configuration of an integrated CCD-MC inventive system during the PFD brine replacement mode of operation, while said MC system is inactive—flow directions indicated by arrows.

FIG. 2C(0) showing the configuration of an integrated CCD-MC inventive system during membrane cleaning of RO skid with permeate, while said CCD system is inactive—flow directions indicated by arrows.

FIG. 2C(1) showing the configuration of an integrated CCD-MC inventive system during membrane cleaning of RO skid with the first type cleaning solution, while said CCD system is inactive—flow directions indicated by arrows.

FIG. 2C(2), showing the configuration of an integrated CCD-MC inventive system during membrane cleaning of RO skid with the second type cleaning solution, while said CCD system is inactive—flow directions indicated by arrows.

FIG. 2C(3), showing the configuration of an integrated CCD-MC inventive system during membrane cleaning of RO skid with the third type cleaning solution, while said CCD system is inactive—flow directions indicated by arrows.

FIG. 2C(4) showing the configuration of an integrated CCD-MC inventive system during membrane cleaning of RO skid with the first and second types of cleaning solutions simultaneously, while said CCD system is inactive—flow directions indicated by arrows.

FIG. 2C(5), showing the configuration of an integrated CCD-MC inventive system during membrane cleaning of RO skid with the first and third types of cleaning solutions simultaneously, while said CCD system is inactive—flow directions indicated by arrows.

FIG. 2C(6), showing the configuration of an integrated CCD-MC inventive system during membrane cleaning of RO skid with the second and third types of cleaning solutions simultaneously, while said CCD system is inactive—flow directions indicated by arrows.

FIG. 3A, showing the configuration of an integrated CCD-MC inventive system wherein said MC system comprises a service pump, during the CCD mode of operation, while said MC system is inactive—flow directions indicated by arrows.

FIG. 38, showing the configuration of an integrated CCD-MC inventive system wherein said MC system comprises a service pump, during the PFD brine replacement mode of operation, while said MC system is inactive—flow directions indicated by arrows.

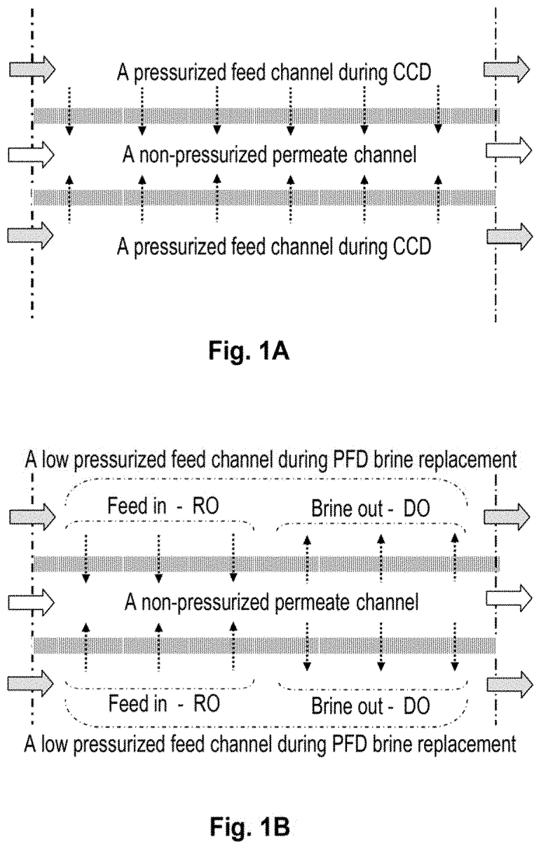

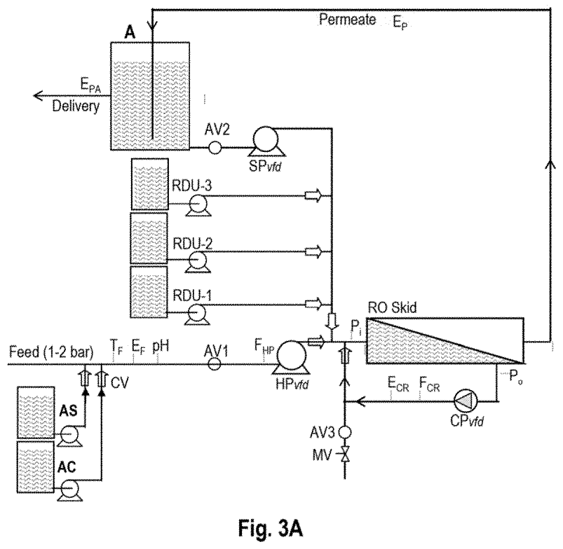

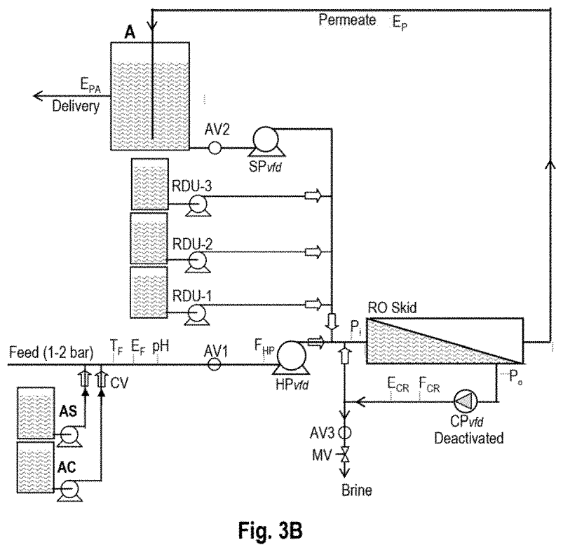

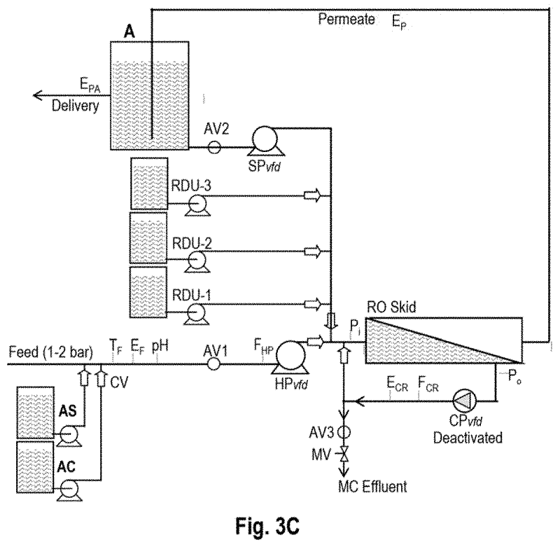

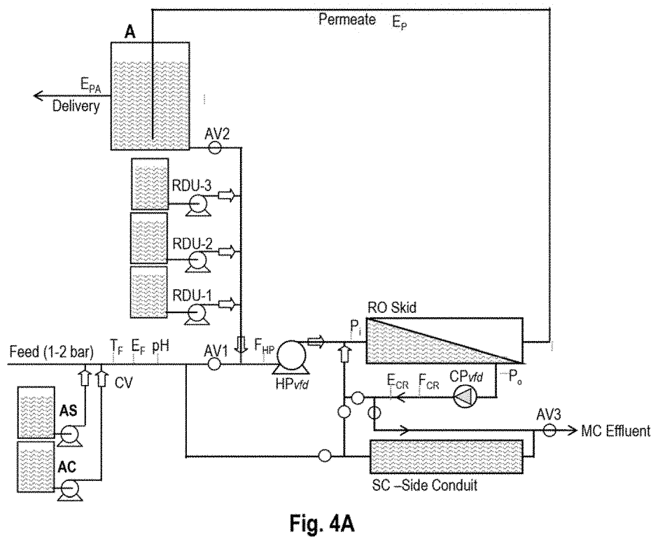

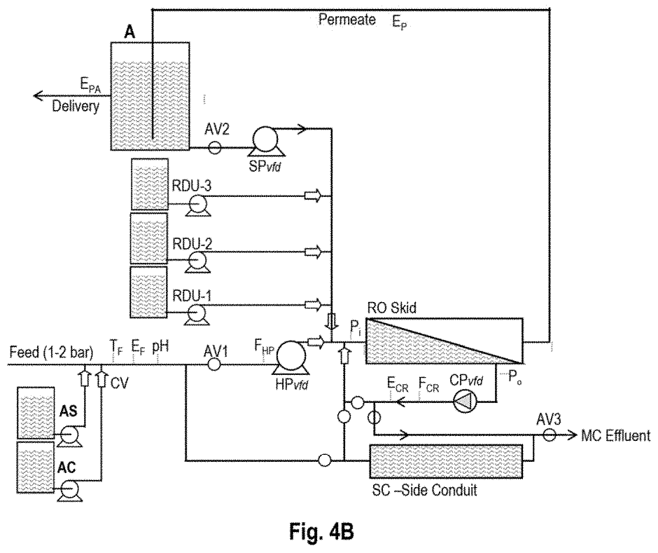

FIG. 3C showing the configuration of an integrated CCD-MC inventive system wherein said MC system comprises a service pump, during membrane cleaning of RO skid with permeate, while said CCD system is inactive—flow directions indicated by arrows.

FIG. 4A, showing the configuration of an integrated RO-MC inventive system wherein said RO is a CCD unit with a side conduit, during membrane cleaning of RO skid with permeate, while CCD system is inactive—flow directions indicated by arrows.

FIG. 4B, showing the configuration of an integrated RO-MC inventive system wherein said RO system is a CCD unit with a side conduit and said MC system comprises a service pump, during membrane cleaning of RO skid with permeate, while CCD system is inactive—flow directions indicated by arrows.

FIG. 5A, showing the configuration of an integrated RO-MC inventive system wherein said RO is a conventional PFD system, during membrane cleaning of RO skid with permeate, while said RO system is inactive—flow directions indicated by arrows.

FIG. 5B, showing the configuration of an integrated RO-MC inventive system wherein said RO system is a conventional PFD system and said MC system comprises a service pump, during membrane cleaning of RO skid with permeate, while said RO system is inactive—flow directions indicated by arrows.

### DETAILED DESCRIPTION OF THE INVENTION

The invention pertains to integrated systems of reverse osmosis (RO) units and membrane cleaning (MC) means (RO-MC) for preventions of fouling by brief (≤8 min) MC sequences with different MC reagents under RO and/or DO conditions, performed automatically at desired time intervals (e.g., once a day or several days) in order to remove newly created fouling deposits off membrane surfaces at an early stage; thereby, preventing their accumulation and circumventing the need for CIP. RO in said integrated RO-MC systems applies to conventional RO units or CCD units, with a greater cleaning effectiveness expected for the latter system of single-stage configurations and skids made of short modules, each of a ¾ element-number; wherein, the MC process should be facile and fast (≤8 minute). The operation of said integrated systems proceeds on an alternating basis with RO mode experienced over 99.5% of the time and this implies a negligible loss of daily permeate productivity to prevent membranes fouling and avoid the need for CIP. In case of systems with conventional RO units with staged modules, each of a six element-number, the MC cleaning effectiveness is expected to decline downstream from the head element as function of an increased element-number line with cleaning needs.

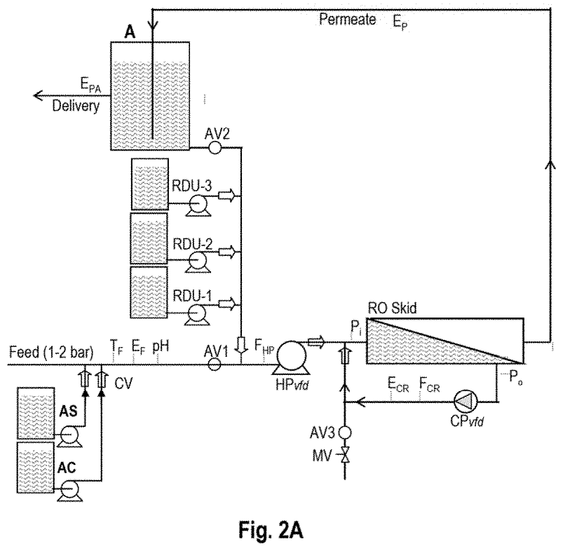

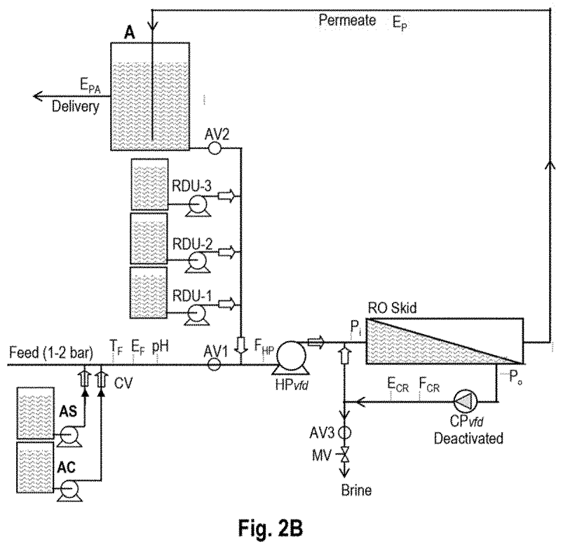

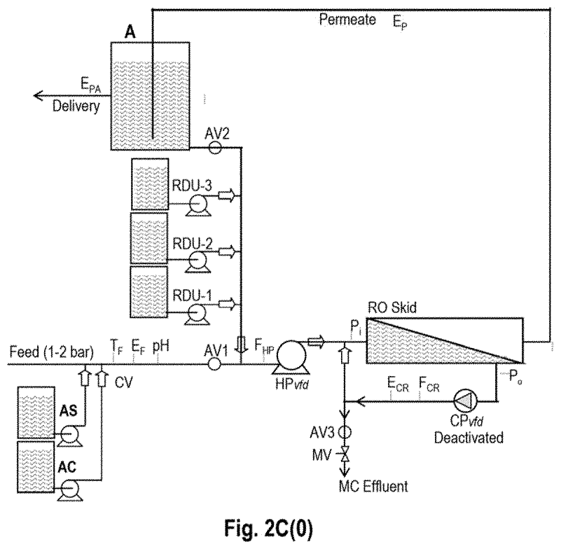

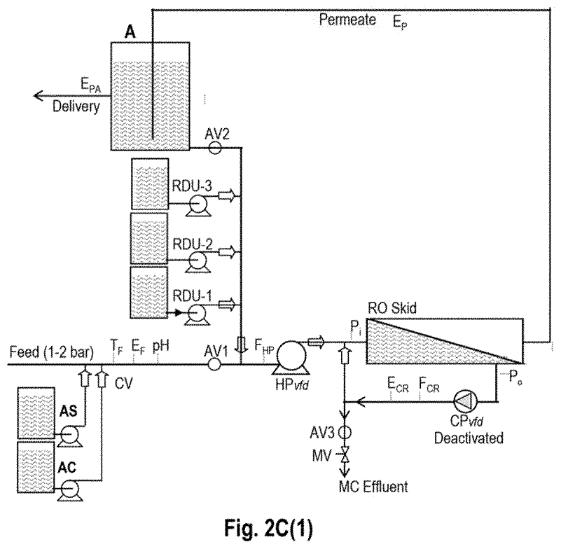

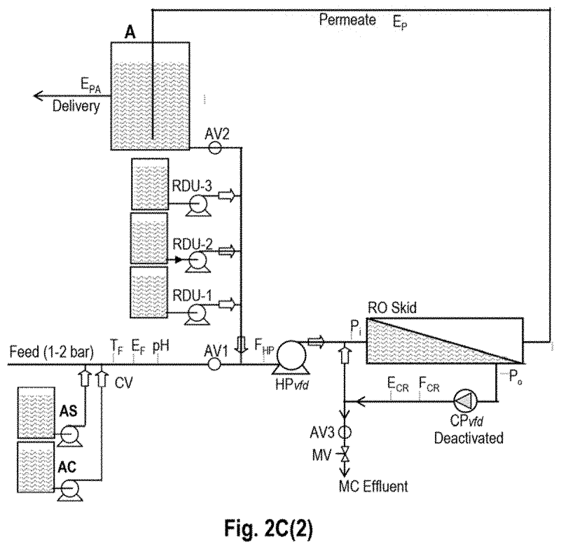

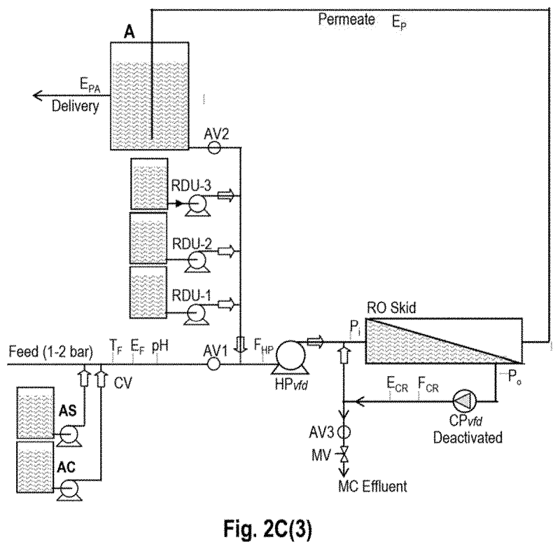

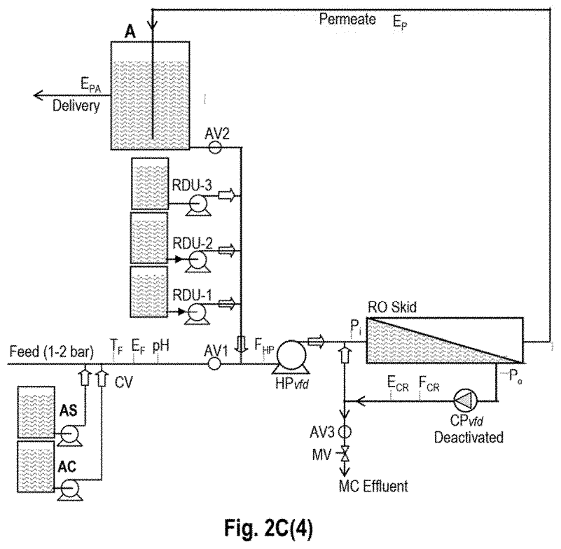

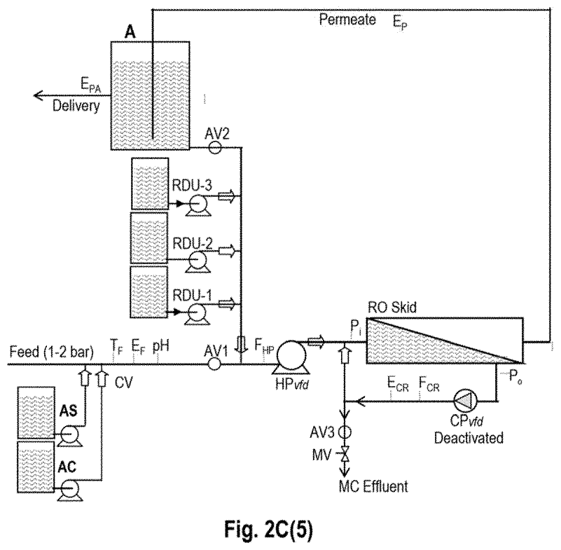

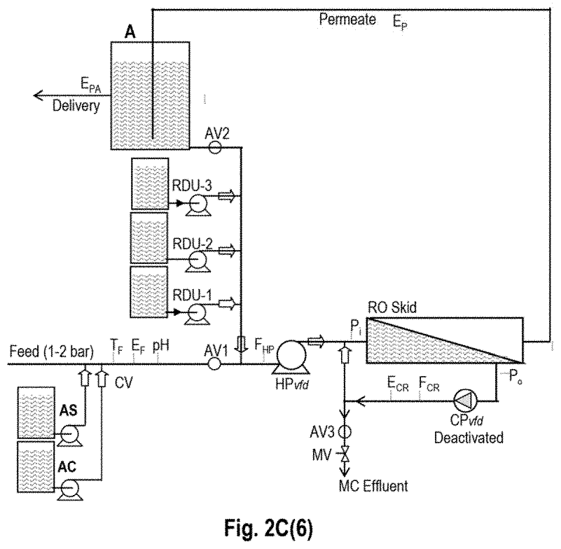

The preferred embodiment of the inventive integrated systems with RO units based on the CCD PCT/IL2005/000670 technology which reveal design features, components, lines, valve means, monitoring means and operational configurations, including flow direction per each step in the process are displayed in FIGS. 2A and B→FIG. 2C(0); 2C(1); 2C(2); 2C(3); 3C(4); 2C(5) and 2C(6). The inventive system configurations in FIG. 2(AB) display an active CCD unit and a passive MC unit; whereas, the inventive system configurations in FIG. 2C(0, 1, 2, 3, 4, 5, and 6) pertain to active MC means and a passive CCD unit. The design features of said inventive system comprise a feed line to the high pressure pump equipped with a variable frequency drive means (HP_{vfd}); an actuated valve means (AV1) on said feed line upstream from said high pressure pump; delivery units of antiscalant (AS) and acid (AC) each comprising a reservoir tank, a line to a delivery pump, and a check-valve means (CV) on supply lines of AS and AC to said feed line upstream of AV1; a pressurized feed line from said HP_{vfd} to the inlet of said RO skid; a pressurized concentrate recycling line from outlet to inlet of said skid; a circulation pump with a variable frequency derive means (CP_{vfd}) on said concentrate recycling line; a line extension from said concentrate recycling line downstream of said CP_{vfd} with an actuated valve means (AV3) and a manual valve means with an adjustable opening mechanism (MV) downstream of said AV3; a non-pressurized permeate line from said skid outlet to the bottom of a permeate tank (A); a permeate delivery line from said A to customers; a permeate delivery line with an actuated valve means (AV2) from said A to said MC means comprising three reagent delivery units [RDU-1, RDU-2 and RDU-3; each comprising of a reagent tank, a reagent line to a delivery pump and thereafter to said MC line through a check-valve means]; a connection of said MC line with check-check means to said feed line to said CCD unit upstream of said HP_{vfd} and downstream of said AV1.

The preferred embodiment of the inventive system in FIG. 2 also contains online monitoring means for process control and performance evaluation, including such for temperature (T_{F}), electric conductivity (E_{F}), pH, and flow/volume (F_{HP}) in said feed line; pressure at inlet (Pᵢ) and outlet (Pₒ) of said concentrate recycling line of said skid; electric conductivity (E_{CR}) and flow/volume (F_{CR}) in said concentrate recycling line; and electric conductivity in said permeate line from said skid (E_{P}) and said permeate delivery line from A to customers (E_{PA}).

The performance of the preferred embodiment of the inventive system in FIG. 2 proceeds by two fully controllable modes; one of consecutive CCD sequences with a brief PFD step for brine replacement by feed after each sequence, and the other of a brief (≤8 min) MC sequence once a day or several days, whereby fouling and/or scaling deposits are removed from membrane surfaces and their build-up prevented. MC proceeds by admitting permeate and permeate solutions of different effective cleaning reagents in succession to the membrane elements in said skid through the reagent delivery units (RDU-1, RDU-2, and RDU-3) according to a predefined sequence of specific delivery rates; thereby, creating inside the elements an effective MC tie-line for removal of al the deposits created on membrane surfaces over the elapsed period (once a day or several days depending on the type foulants). The selection of said reagents, their concentrations and delivery rates, during the MC sequences will depend on the type of the fouling and/or scaling constituents of a specific feed source. The performance steps of the preferred embodiment are outlined in FIG. 2A→FIG. 2C(6) with emphasis on active configurations with regards to position of valves, flow directions, actuation control and monitoring means.

FIG. 2A discloses the configuration of said integrated system during a CCD sequence controlled by selected operational set-points of fixed flow rates of feed and permeate (Q_{HP}=Q_{P}), cross-flow (Q_{CP}), and a desired batch recovery (R) determined from the continuously monitored cumulative volumes of feed (ΣV_{HP}) and permeates (ΣV_{P}). During CCD which is experienced most of the time (≥90%), both HP and CP pumps operate according their selected set-points and desalination proceeds with fixed flux and module recovery [MR=100*Q_{HP}/(Q_{HP}+Q_{CP})=100*Q_{P}/(Q_{P}+Q_{CP})] to the desired batch sequence recovery [R=100*(ΣV_{P})/(ΣV_{HP} Vᵢ)), where Vᵢ is the intrinsic volume of the closed circuit], which is the initiation signal of the next stage. CCD proceeds with active AS and AC reagent delivery units and an inactive MC means, with positions of valve means and flow directions displayed in FIG. 2A.

FIG. 2B discloses the configuration of said integrated system during a step of PFD brine replacement by fresh feed after each CCD sequence. During said PFD step which is experienced ≤10% of the time, only the HP pump operates with a selected flow rate set-point different than that of CCD, with active AS and AC delivery units, inactive CP and MC means, with position of valves and flow directions displayed in FIG. 2B. The desired minimum applied pressure during this stage is attained by the opening selection of said manual valve means (MV). The recommended minimum pressure set-up during this stage should be lower than the osmotic pressure of the replaced brine in order to enable a brief permeate backwash through the semi-permeable membranes by direct osmosis (DO). The termination of this stage and resumption of a new CCD sequence takes place when the monitored volume of replaced brine (F_{CR}) from the closed circuit of said RO skid slightly exceeds the fixed intrinsic volume (Vᵢ) of said closed circuit.

FIGS. 2C(0→6) disclose the configurations of said system during the MC sequences which are experienced less than 0.5% of the time if performed once a day. Initiation of the MC sequence starts with the termination signal of the last PFD brine replacement step of the defined time interval (one a day or several days), steps duration said sequence are controlled by a timer which also triggers the resumption of CCD after the completion of the MC sequence. During the MC mode of operation, RO is stopped, and said RO skid receives only permeate with and/or without permeate solutions of cleaning reagents from the reagent delivery units (RDU-1, RDU-2, and RDU-3) in a predefined MC sequence determined by delivery step-points of flow rate and time duration per each reagent delivery unit. The reagent delivery units may be actuated alternately or simultaneously during the MC sequence to enable a maximum MC effect. The MC mode proceeds with a selected HP_{vfd} flow rate at a relatively low applied pressure (pₘᵢₙ) with osmotic pressure of specific delivered reagents (π) to said RO skid meet the conditions of reverse osmosis (RO: π<pₘᵢₙ), or direct osmosis (DO: π>pₘᵢₙ or their absence (π=pₘᵢₙ) according to the predefined MC selected sequence. For example, if one of said RDU units in FIG. 2C comprises a concentrated electrolyte solution (e.g., RDU-1, NaCl), it simultaneous controlled actuation with each of the remaining RDU units will define the osmotic pressure at inlet to said RO skid and thereby, enable MC performed under RO or DO conditions or in their absence. MC prospects of said MC means of the preferred embodiment in FIG. 2 are as followed:

FIG. 2C(0): Membrane surfaces cleaning in said RO skid with permeate under RO conditions.

FIG. 2C(1): Membrane surfaces cleaning in said RO skid under either RO or DO conditions, or their absence, with an electrolyte permeate solution delivered from said RDU-1 unit, with exact MC conditions determined by the selected applied pressure and the flow rate delivery of said electrolyte solution.

FIG. 2C(2): Membrane surfaces cleaning in said RO skid under either RO or DO conditions, or their absence, with the selected MC solution in said RDU-2 unit, under the specific conditions determined by the selected applied pressure and flow rate delivery of said MC solution in said RDU-2 unit

FIG. 2C(3): Membrane surfaces cleaning in said RO skid under either RO or DO conditions, or their absence, with the selected MC solution in said RDU-3 unit, under the specific conditions determined by the selected applied pressure and flow rate delivery of said MC solution in said RDU-3 unit

FIG. 2C(4): Membrane surfaces cleaning in said RO skid under either RO or DO conditions, or their absence, with the selected cleaning solutions in said RDU-1 and RDU-2 units simultaneously, under the specific conditions determined by the selected applied pressure and flow rates of said RDU-1 and RDU-2 units; wherein, the former unit provides an electrolyte solution to enable an osmotic pressure modification.

FIG. 2C(5): Membrane surfaces cleaning in said RO skid under either RO or DO conditions, or their absence, with the selected cleaning solutions in said RDU-1 and RDU-3 units simultaneously, under the specific conditions determined by the selected applied pressure and flow rates of said RDU-1 and RDU-3 units; wherein, the former unit provides an electrolyte solution to enable an osmotic pressure modification.

FIG. 2(6): Membrane surfaces cleaning in said RO skid under either RO or DO conditions, or their absence, with the selected cleaning solutions in said RDU-2 and RDU-3 units simultaneously, under the specific conditions determined by the selected applied pressure and flow rates of said RDU-2 and RDU-3 units.

The effectiveness of the MC procedure according to the preferred embodiment of the inventive integrated system in FIG. 2 arises from the need to remove only small amounts of fouling and scaling deposits off membrane surfaces before such deposits become larger and require extensive CIP procedures for their removal, or may even cause an irreversibly damage to the membranes. Common fouling deposits on RO membrane surfaces normally comprise of organic and/or bioorganic substances and/or inorganic scaling constituents including such with silica and polymerized silica coatings with either metal hydroxides or organic substances. If said deposits are at their embryonic stage, their effective removal under mild conditions could be accomplished with gentle reagents such as citric acid to remove calcium carbonate and metal oxides; sodium hydroxide and/or Na-EDTA (sodium salt of ethylenediaminetetraacedic acid) and/or STPP (sodium tripolyphosphate) solutions at pH-10 to remove sulfates of calcium, strontium and barium as well as organic and/or inorganic/organic foulants; and diluted hydrofluoric or fluorosilicic acids to remove silica and/or polymerized silica deposits.

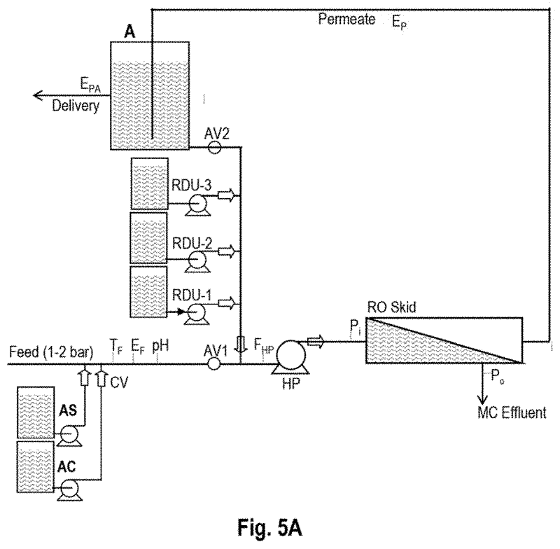

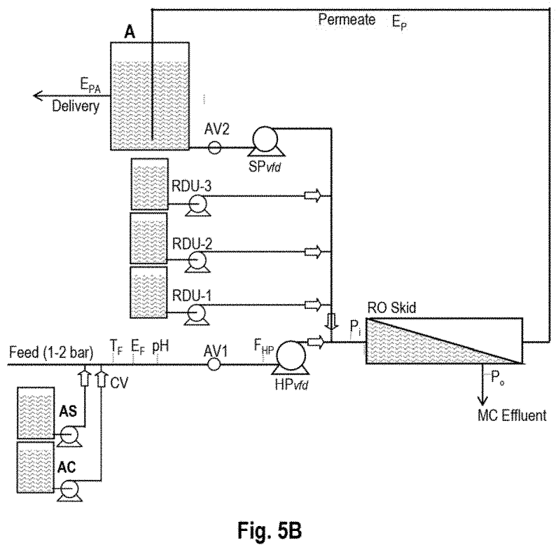

The MC mode according to the integrate RO-MC system is carried out with permeate and permeate cleaning solutions under a low applied pressure and sufficient pressurizing means for such a purpose may be created a low pressure service pump of controllable flow means (SP_{vfd}) at outlet of said permeate reservoir (A) with a feed line directly connected to the inlet of said RO skid, avoiding the principle RO pressure pump (HP_{vfd}). The use of a service pump (SP_{vfd}), instead of HP_{vfd}, during MC operations in the context of the inventive system is illustrated in FIG. 3(A-C) by a modified preferred embodiment of said CCD-MC system; wherein, said MC operations proceed by an exact analogy with the illustrated steps in FIG. 2C(0)→FIG. 2C(6). FIGS. 3A and 38B describe the operational configurations of said modified system during its active CCD and PFD desalination modes, respectively, while said MC means including the dedicated service pump (SP_{vfd}) remain idle. FIG. 3C describes the operational configuration of said modified system during its MC mode while desalination is stopped, showing membrane surfaces cleaning with permeate by analogy with the step in FIG. 2C(0) of the unmodified system. The other MC steps of said modified system proceed by exact analogy to those described in FIG. 2C(1)→2C(6) of said unmodified system.

The preferred embodiment modification of the inventive CCD-MC integrated system where said CCD unit comprises a side conduit according to PCT/IL2004/000748 is displayed in FIG. 4(AB), showing a MC configuration through the engagement of the HP_{vfd} principle pump (4A) or through a service pump (SP_{vfd}) instead (48). The operational configurations in FIG. 4(AB) describe an active MC mode of membrane surfaces with permeate while desalination is stopped by analogy with the step in FIG. 2C(0) of the unmodified system. The other MC steps of said modified systems proceed by exact analogy to those described in FIG. 2C(1)→2C(6) of said unmodified system.

The inventive integrated RO-MC system is not confined to CCD units and may apply to conventional RO units and such integrations are illustrated in FIG. 5(AB) through the principle pump (HP) in said units (5A) or through a service pump (SP_{vfd}) instead (5B). The operational configurations in FIG. 5(AB) describe an active MC mode of membrane surfaces cleaning with permeate while desalination is temporarily stopped by analogy with the step in FIG. 2C(0) of the unmodified system. The other MC steps of said modified systems proceed by exact analogy to those described in FIG. 2C(1)-2C(6) of said unmodified system. Conventional RO units of a single-stage such as for seawater or of two or three stages for brackish water comprise of long modules, each of 6/8 element-number, in contrast with short modules, each of ¾ element-number, commonly used by CCD techniques, and this difference may suggest the greater effectiveness of integrated RO-MC systems where the RO unit is of a CCD type.

It will be understood to the skilled in the art that the inventive integrated RO-MC systems may comprise different type of RO units in combination with a MC unit for periodic cleaning of membrane surfaces from fouling and scaling deposits and that preferred embodiments of the inventive systems in FIG. 2, FIG. 3. FIG. 4, and FIG. 5 are schematic and simplified and are not to be regarded as limiting the invention, but as several examples of many for the diverse implementation of the invention. In practice, systems according to the inventive method may comprise many additional lines, branches, valves, and other installations and devices as deemed necessary according to specific requirements while still remaining within the scope of the invention's claims.

It will be understood to the skilled in the art that means for pressurizing feed, boosting feed pressure, recycling of concentrate, reagent delivery unit, flow manipulation, and online monitoring devices of pH, temperature, pressure, flow/volume, electric conductivity are comprised of ordinary commercial components such as a pressure pump, a circulation pump, a valve device, or several such components that are applied simultaneously in parallel or in line as appropriate. It is further understood that the referred monitoring means and their transmitted signals to the computerized control board are essential for the actuation and control of specific components within said system as well as for the entire system.

It will be obvious to the skill in the art that the design of the inventive systems is not confined by the number of modules and/or element-number per module and/or the type of modules and elements in each said RO skid, nor by the number of reagent delivery units in the MC unit, and therefore, said inventive systems my also apply to large scale desalination plants for cleaning of membrane surfaces from deposits and thereby avoid the need for CIP.

While the invention has been described hereinabove in respect to particular embodiments, it will be obvious to those versed in the art that changes and modifications may be made without departing from this invention in its broader aspects, therefore, the appended claims are to encompass within their scope all such changes and modifications as fall within the true spirit of the invention.

### Example

An integrated RO-MC system according to FIG. 2 made of a CCD unit of single ME4 (E=ESPA2-MAX) module design of a 65 liter intrinsic volume and a MC unit of three controllable reagent delivery units of 30% NaCl (RDU-1), 30% Na-EDTA of pH=10 (RDU-2); and 30% HF (RDU-3). Assumed flow pressure conditions during the MC operation: 4.0 m³/h(66 l/min) at 1.5 bar of permeate delivery pump; 7.2 l/min flow rate of RDU-2 pump for Na-EDTA cleaning solution delivery to membranes of 3% of said reagent; and 0.217 l/min (217 ml/liter) flow rate of RDU-3 pump for HF cleaning solution delivery to membranes of 0.1% (π=1.25 bar based on Ka=6.8×10⁻⁴) of said reagent. The selected flow rates of RDU-1 for NaCl osmotic pressure modifications are as followed: 0.314 l/min (314 ml/min) for 0.1875% NaCl modified solution delivery to membranes (π=1.5 bar equivalent to applied pressure (1.5 bar) for avoiding RO or DO; 0.327 lpm (327 ml/min) for 0.15% NaCl modified solution delivery to membranes of π=1.2 bar; and 0.656 l/min (656 ml/min) for 0.3% NaCl modified solution delivery to membranes of τ=2.4 bar.

The illustrated example pertains to fouling and scaling prevention in a CCD system for 95% desalination recovery of treated domestic effluents where the principle fouling constituents in the brine (14,500 ppm TDS) comprise of 500 ppm Ca; 4,400 ppm SO₄; 170 ppm SiO₂; and 140 ppm TOC. Ordinarily, CIP in said application without the inventive MC system is required once a month with some loss of membranes' activity, whereas, the engagement of the MC unit in the context of the inventive system for 8 minutes once every two days should circumvent the need for CIP and prevent loss of membranes' activity.

During the MC mode of operation desalination is stopped and the permeate delivery pump to the MC unit is actuated at a flow rate of 4.0 m³/h (66 l/min) and 1.5 bar during the entire MC sequence and this implies that the entire intrinsic volume of the module (65 liter) every minute.

The sequence of the MC reagents delivery to membrane surfaces proceeds by steps as following:

1^{st} step: 70 sec actuation of RDU-1 pump with flow rate of 656 ml/min for washing of membranes inside-out under DO conditions (π−Pₐₚ≈13 psi) from past remains.
2^{nd} Step: 135 sec actuation of RDU-2 pump with flow rate of 7.2 l/min simultaneously with RDU-1 at flow rate of 327 ml/min) to enable membrane cleaning with 3% Na-EDTA cleaning solution at pH≈10 under mild RO conditions (Pₐₚ−π≈4 psi) for removal of organic foulants and inorganic coatings including silica off membrane surfaces.
3^{rd} Step: 70 sec actuation of RDU-1 pump with flow rate of 656 ml/min for washing of membranes inside-out under DO conditions (π−Pₐₚ≈13 psi) of previous step remains.
4^{th} Step: 135 sec actuation of RDU-3 pump with flow rate of 217 ml/liter to enable membrane cleaning with 0.1% HF cleaning solution under mild RO conditions (Pₐₚ−π≈4 psi)—the osmotic pressure of 0.1% HF (π=1.25 bar) is based on Ka=6.8×10⁻⁴ and van't Hoff at 25° C. This step in the sequence is intended for further removal of silica, polymerized silica and iron oxides off membrane surfaces.
5^{th} Step: 70 sec actuation of RDU-1 pump with flow rate of 656 ml/min for washing of membranes inside-out under DO conditions (π−Pₐₚ=13 psi) of previous step remains.

The above tie-line MC sequence of 480 second (8 minute) duration is an illustrative example only in light of the projected fouling constituents on membrane surface. The number of MC steps and reagents for MC should relate specifically to the nature of fouling deposits and the effective reagents for their removal. For instance, in case of a high silica fouling propensity, the MC procedure should more heavily rely on HF cleaning solution of greater than 0.1% concentration and a longer contact time with membranes surfaces.

1. An integrated system (RO-MC) comprising a reverse osmosis (RO) desalination unit with a membrane cleaning (MC) means to avoid accumulation of fouling deposits on membrane surfaces and need of “clean in place” procedures (CIP), comprising:
a RO unit of said system comprising a RO skid of a single module or many modules with their inlets and outlet connected in parallel, a feed line to the pressurizing means of said RO unit with delivery units of antiscalant (AS) and add (AC); a permeate line from said RO skid to the bottom of a permeate tank, a valve means and control means to enable desalination under defined flow, pressure and recovery conditions with brief stops each specified duration for membrane cleaning;
MC cleaning means in said system comprising a permeate delivery line from the bottom of said permeate tank to module(s) in said RO skid with controllable flow and pressure means through a valve means, one or more than one MC reagent delivery unit (RDU) connected to said MC permeate delivery line to said RO skid, each said RDU unit comprises a reagent feed tank and a line with controllable pump and a valve means for MC reagent delivery at a selected flow rate over a specified time interval to membrane(s) in said RO skid through said permeate line in said MC means;
a programmable computer means which define the followings: flow and pressure conditions in said RO unit and its selected operational time duration while said MC means remain inactive; activation of said MC means and deactivation of said RO unit for a brief cleaning procedure interval; a controllable MC procedure of a predefined flow rate and pressure in said permeate delivery line to said RO skid and for each of the connected RDU units to said permeate line which may be actuated alternately or simultaneously over predefined time intervals; termination of said MC procedure and resumption of desalination by said RO unit in said system until the next scheduled said MC cleaning procedure and, performance evaluation means of said system by online monitored means of electric conductivity, pH, pressure, pH, flow/volume in the specified lines as appropriate.

2. An integrated system according to claim 1 wherein said pressurizing means of said RO unit also apply to create flow and pressure conditions inside said permeate delivery line to said RO skid when destination is briefly stopped for membrane cleaning, or alternatively, creation of flow and pressure conditions inside said permeate delivery line to said RO skid by a service pump (SP) means instead of the pressurizing means of said RO unit.

3. An integrated system according to claim 1 wherein said RO unit in said system refers to a close circuit desalination (CCD) unit which executes consecutive batch desalination sequences under fixed flow and variable pressure conditions with entire concentrate being recycled from outlet to inlet of said RO skid and mixed with pressurized feed at its inlet with flow rates of pressurized feed and permeate being equal.

4. An integrated system according to claim 1 wherein said RO in the said system refers to an open circuit continuous plug flow desalination unit wherein a fixed pressurized flow stream at inlet to said RO skid spits at its outlet into a pressurized brine stream and a non-pressurized permeate stream.

5. An integrated system according to claim 1 wherein each said regent delivery unit provides a different reagent to said permeate line of said MC means, one of which comprises a concentrated electrolyte solution (e.g., NaCl) for the purpose of osmotic pressure (π) modification inside said permeate line of said MC means of a selected applied pressure (pₐ) and thereby, enable executing a MC sequence with specific reagents under reverse osmosis (pₐ>π) and/or direct osmosis (pₐ<π) conditions, or their absence (pₐ=π), with said conditions determined by net driving pressure (NDP=pₐ−π) manipulations.

6. An integrated system according to claim 1 with said online monitoring means include temperature (T_{F}), electric conductivity (E_{F}), pH and flow/volume (F_{HP}) in said feed line; pressure at inlet (Pᵢ) and outlet (Pₒ) of said RO skid in said concentrate recycling line (ΔP=Pᵢ−Pₒ) wherein conductivity (E_{CR}) and flow/volume (F_{CR}) are also monitored, and conductivity in said permeate line from said RO skid to said permeate tank (Eₚₐ) as well as in said permeate delivery from permeate tank to customers;

7. Actuation of said integrated RO-MC system according to claim 1 by the following steps;
7.1 Desalination by said RO unit while said MC means remain inactive;
7.2 Activation of said MC system instead of said RO system after a selected time interval (e.g., once a day or several days) by a signal from said a programmable computer means,
7.3 Execution of a brief MC sequence by said MC means while said RO unit stopped with different cleaning reagents, each step in said sequence proceeds under the predefined selected RO or DO conditions, or their absence, with entire said MC sequence, including actuation order of said reagent delivery units, their flow rates and operational time intervals, fully controlled by said a programmable computer means,
7.4 Termination of said MC sequence after its completion and resumption of desalination by said RO unit determined by said a programmable computer means.

8. Execution of said MC sequence with said MC reagents according to claim 1 for removing organic and/or inorganic deposits from membrane surfaces at their infancy, including silica and polymerized silica coatings with either metal hydroxides or organic matters, by the following applications;
8.1 washing membrane surfaces of elements inside said RO skid by a permeate solution with an electrolyte (e.g., NaCl) of an osmotic pressure (π) slightly higher than that of the selected applied pressure (p) and thereby, create very mild direct osmosis (DO) conditions (π≥pₐ) for an inside out cleaning effect on membrane surfaces before exposed to specific cleaning solutions;
8.2 subjecting membrane surfaces in elements of said RO skid to a permeate solution of a much higher osmotic pressure than that of the selected applied pressure (π>pₐ) and thereby create a strong DO inside out backwash effect which should assist the breakdown of fouling deposits off said membrane surfaces and their removal;
8.3 subjecting membrane surfaces in elements of said RO skid to a permeate solution of sodium hydroxide and/or sodium-EDTA (ethylene-diamine-tetraacetic acid) and/or sodium tripolyphosphate and/or sodium dodecylbenzene sulfonate and/or reagents alike, at high pH (˜10) under mild RO conditions (π<pₐ) and thereby, facilitate the removing of organic and/or bio-organic and/or certain inorganic left over coating off said membrane surfaces;
8.4 subjecting membrane surfaces in elements of said RO skid to a diluted permeate solution of hydrofluoric solution or fluorosilicic acid or ammonium biflouride under mild RO conditions (π<pₐ) and thereby, facilitate the removal of silica and/or polymerized silica coatings remains off said membrane surfaces;
8.5 subjecting membrane surfaces in elements of said RO skid to a permeate wash (no reagents) of interior channels of membrane element supplemented by a strong permeate backwash effect by DO (π>pₐ) for removal of al remain traces of cleaning reagents used during said MC sequence.
